(19) United States
(12) Patent Application Publication
(10) Pub. No.: US 2022/0383209 A1
(43) Pub. Date: Dec. 1, 2022

(54) INFORMATION PROVISION DEVICE, INFORMATION PROVISION METHOD, AND COMPUTER READABLE MEDIUM STORING INFORMATION PROVISION PROGRAM

(71) Applicant: Rakuten Group, Inc., Tokyo (JP)

(72) Inventors: Ryohei TAKUMA, Tokyo (JP); Masahiro KUWAHARA, Tokyo (JP); Asami EBISAWA, Tokyo (JP)

(73) Assignee: Rakuten Group, Inc., Tokyo (JP)

(21) Appl. No.: 17/748,282

(22) Filed: May 19, 2022

(30) Foreign Application Priority Data
May 25, 2021 (JP) 2021-87730

(51) Int. Cl. G06Q 10/02; G06Q 10/10; G01W 1/10

(52) U.S. Cl. CPC G06Q 10/02; G06Q 10/1093; G01W 1/10; G01W 2203/00

(57) ABSTRACT

An information provision device acquires weather information indicating weather of at least one golf course at each of future playing frames included in playing frames of the at least one golf course. The information provision device acquires history information indicating logs of whether any of specific reservation holders canceled a reservation for any of past specific playing frames. Weather at each of the past specific playing frames is predetermined weather that possibly has a negative impact on playing golf. Each of the specific reservation holders has a reservation for one of the future playing frames. The information provision device controls, based on the acquired history information, display priorities of information on specific future playing frames at which weather indicated by the acquired weather information is the predetermined weather, among in the future playing frames.

### CROSS-REFERENCE TO RELATED APPLICATIONS

This application claims priority to Japanese Patent Application No. 2021-087730 filed on May 25, 2021, the entire disclosure of which, including the specification, claims, drawings, and abstract, is incorporated herein by reference.

### BACKGROUND

### Technical Field

The present invention relates to a technical field of a method of providing information regarding golf courses that can be reserved in a system for reserving the golf courses.

### Related Art

Conventionally, a system that enables reservation of a golf course using a network such as the Internet is known. In the reservation of the golf course, a target of the reservation is identified by, for example, a combination of a golf course, front nine/back nine, a playing date, and a tee time. This combination is referred to as a playing frame for convenience. The reservation system for golf courses provides a user with, for example, information on a list of playing frames meeting a condition designated by the user. Then, the reservation system executes reservation processing for a playing frame selected by the user from the list.

Typically, one user included in a group who will play golf together makes a reservation fora golf course. Thereafter, on the day of play, the reservation holder, who made the reservation, and companions go to the golf course and play golf. Meanwhile, there is a so-called single person reservation plan as a plan provided from a golf course. In the single person reservation, two or more users can make reservations for the same playing frame. The minimum number of participants is predetermined (for example, two or more persons). An event of golf is determined to be held for a playing frame on which the number of users who made reservations is equal to or more than the minimum number of participants. Thereafter, the users who made the reservations go to the golf course on the day of play and play golf together. For a playing frame on which the number of users who made reservations is still less than the minimum number of participants at a predetermined date and time, the reservations made by all the users are automatically canceled.

In relation to the single person reservation, JP 2009-123151 A discloses a mail distribution system for making a reservation for a group that is not full reserved. In a case where there is a group including only one reservation holder, the mail distribution system sets a play condition and distributes invitation information to users on whom the play condition meets conditions desired by themselves by mail. The play condition is a condition such as a price and the presence or absence of an option. Thereafter, in a case where the group still includes the only one reservation holder, the mail distribution system lowers the price or adds an option. The mail distribution system distributes invitation information to users on whom the changed play condition meets conditions desired by themselves by mail. The play condition may be set depending on the weather. The price is lowered in a case of thunderstorm, or the price is lowered in the rainy season in which the weather is unstable.

### SUMMARY

However, when a reservation holder knows that the weather will be likely to be unsuitable for playing golf according to the weather forecast, they may cancel the reservation by themselves. When the number of reservation holders becomes less than the minimum number of participants because of this cancel, an event of golf at the playing frame is not held. Furthermore, the reservations made by all the other reservation holders are automatically canceled. On the other hand, some reservation holders do not cancel the reservation even in such weather. As a result, the event of golf may be held. For these reasons, it cannot be said that it is always appropriate to uniformly encourage reservations by lowering the price or the like because of bad weather.

The present invention has been made in view of the above points. An object of the present invention is to provide an information provision device, an information provision method, and a computer readable medium storing thereon an information provision program that provide information to promote reservation for a playing frame at which an event of golf will be likely to be held based on weather.

An aspect of the present invention is an information provision device comprising: weather information acquisition means configured to acquire weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame; history information acquisition means configured to acquire history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and control means configured to control, based on the acquired history information, display priorities of information on specific future playing frames included in the future playing frames, wherein weather at each of the specific future playing frames indicated by the acquired weather information is the predetermined weather.

Another aspect of the present invention is an information provision method performed by a computer, the method comprising: acquiring weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame; acquiring history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and controlling, based on the acquired history information, display priorities of information on specific future playing frames included in the future playing frames, wherein weather at each of the specific future playing frames indicated by the acquired weather information is the predetermined weather.

Yet another aspect of the present invention is a non-transitory computer readable medium storing thereon an information provision program, the information provision program causing a computer to: acquire weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame; acquire history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and control, based on the acquired history information, display priorities of information on specific future playing frames included in the future playing frames, wherein weather at each of the specific future playing frames indicated by the acquired weather information is the predetermined weather.

### BRIEF DESCRIPTION OF DRAWINGS

FIG. 1 is a diagram illustrating an example of a schematic configuration of a golf course reservation system S according to an embodiment;

FIG. 2 is a block diagram illustrating an example of a schematic configuration of a golf course reservation server 1 according to an embodiment;

FIG. 3 is a diagram illustrating an example of information stored in databases;

FIG. 4 is a diagram illustrating an example of functional blocks of a system controller 11 in the golf course reservation server 1 according to an embodiment;

FIG. 5 is a diagram illustrating an example of determining a display priority;

FIG. 6A is a diagram illustrating an example of a relationship between a combination of weather and the number of reservation holders and the display priority; FIG. 6B is a diagram illustrating a specific example of determining the display priority;

FIG. 7 is a diagram illustrating an example of display of a list of playing frames;

FIG. 8 is a flowchart illustrating an example of priority determination processing performed by the system controller 11 of the golf course reservation server 1;

FIG. 9 is a flowchart illustrating an example of cancellation rate determination performed by the system controller 11 of the golf course reservation server 1;

FIG. 10 is a flowchart illustrating an example of playing frame list providing processing performed by the system controller 11 of the golf course reservation server 1;

FIG. 11 is a diagram illustrating an example of a relationship between the combination of the weather and the number of reservation holders and the display priority in a case where a target user has a high degree of tendency to cancel reservation of a playing frame at which the weather is bad weather; and

FIG. 12 is a flowchart illustrating an example of playing frame list providing processing performed by the system controller 11 of the golf course reservation server 1.

### DETAILED DESCRIPTION

A detailed description will hereinafter be given of an embodiment of the present invention with consultation of drawings.

### 1. First Embodiment

### [1-1. Configuration of Golf Course Reservation System]

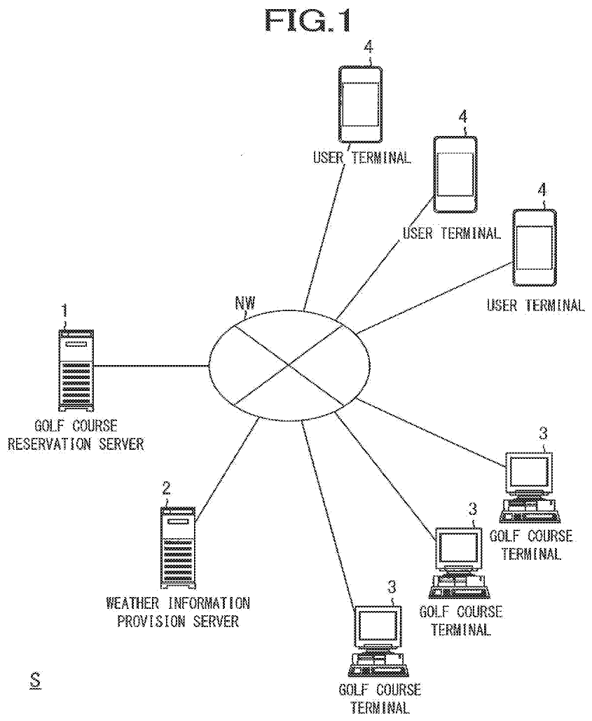

First, an outline of a configuration and functions of a golf course reservation system S according to the present embodiment will be described with reference to FIG. 1. FIG. 1 is a diagram illustrating an example of a schematic configuration of the golf course reservation system S according to the present embodiment.

As illustrated in FIG. 1, the golf course reservation system S includes a golf course reservation server 1, a weather information provision server 2, a plurality of golf course terminals 3, and a plurality of user terminals 4. The golf course reservation server 1, the weather information provision server 2, the respective golf course terminals 3, and the respective user terminals 4 are connected to one another via a network NW. The network NW is constructed by, for example, the Internet, a dedicated communication line (for example, a community antenna television (CATV) line), a mobile communication network (including a base station or the like), a gateway, and the like.

The golf course reservation server 1 is a server device that executes various processings related to a reservation site for reserving golf courses. The golf course reservation server 1 transmits contents such as a web page related to the reservation site in response to a request from the golf course terminal 3 or the user terminal 4. The golf course reservation server 1 performs processing on reservation for golf courses in response to a request from the user terminal 4. The contents distributed by the golf course reservation server 1 to the user terminal 4 include a content including a list of available playing frames (alternatively, time frames or start frames). The playing frame is a combination of a location where golf is played as a reservation target and a playing time. The location where golf is played is indicated at least by a golf course. The location where golf is played may be a combination of a golf course and a set of nine holes. The set of nine holes indicates one of a plurality groups into which all the holes in the golf course are divided. Each of the plurality groups is constituted by consecutive holes. Generally, as the set of nine holes, there are front nine (first to ninth holes) and back nine (tenth to eighteenth holes). The playing time may be indicated by at least a playing date. The playing date is the date of playing golf. The playing time may be a combination of the playing date and a tee time. The tee time is a time at which golf play starts. The tee time may be preset at predetermined time intervals (for example, intervals of seven minutes). When reserving a golf course, the user may be required to designate a plan. The plan indicates details of a service provided by the golf course to a user who uses the golf course. The list of playing frames is a list of combinations of available locations where golf is played and playing times, and may show a plan to be provided to a user for each combination. A search result page is an example of the content including the list of playing frames. The search result page is a web page showing a list of playing frames that meet search conditions designated by the user. Examples of the search conditions include a fee, a region or prefecture in which the golf course is located, a playing date, a period of time in which golf play starts, details of a plan, and the like. A front page for single person reservation is another example of the content including the list of playing frames. A list of playing frames that meet a predetermined condition may be displayed on the front page. The predetermined condition may be, for example, that the playing date is tomorrow, the golf course is in a specific region, and one or more another reservation holders already exist. The user can select anyone of the playing frames from the list of playing frames and make a reservation

Some available golf courses provide a single person reservation plan. The single person reservation plan is a plan that allows a reservation holder to participate in golf performed at a playing frame reserved by the reservation holder, without the reservation holder making their friends to participate. In this single person reservation plan, each of a plurality of users can reserve the same playing frame. The minimum number of participants has been predetermined. Then, when the number of reservation holders becomes equal to or more than the minimum number of participants before a reservation deadline for the target playing frame, they can play golf at the playing frame. In this case, the plurality of users who have reserved the same playing frame will play golf together as a group. On the other hand, in a case where the number of reservation holders does not reach the minimum number of participants by the reservation deadline, the reservations made by all the reservation holders are canceled by the golf course reservation server 1. As a result, the reservation holders cannot play golf. The minimum number of participants is generally two. However, the minimum number of participants may be one, three, or four. For example, each golf course may be able to set the minimum number of participants for each plan in advance. Details of another service offered in the single person reservation plan may be different for each golf course. Furthermore, one golf course may provide a plurality of types of single person reservation plans. Note that, in the present embodiment, a description of reservation of plans other than the single person reservation plan will be omitted.

The weather information provision server 2 is a server device that provides weather information regarding weather in each place. For example, the weather information provision server 2 provides weather forecast information indicating weather predicted at the present time and past weather information indicating the past weather. For example, a predetermined region (for example, Japan or the like) is divided into a plurality of meshes. The mesh may be, for example, a rectangular region whose length of each side is a predetermined distance (for example, 1 km or the like). The weather information provision server 2 may be able to provide the weather information in units of meshes, or may be able to provide weather information in units of prefectures or city blocks. When receiving information indicating future date and time together with position information indicating longitude and latitude, an address, a zip code, or the like from another computer, the weather information provision server 2 may transmit the weather forecast information corresponding to the position and the date and time to the computer. The weather forecast information may include, for example, at least one of a precipitation percentage, a precipitation amount, a wind speed, and a temperature. In addition, when receiving information indicating the past date and time together with the position information, the weather information provision server 2 may transmit the past weather information corresponding to the position and the date and time. The past weather information may include, for example, at least one of a precipitation amount, a wind speed, and a temperature.

Each golf course terminal 3 is a terminal device used by an employee of a golf course. Examples of the golf course terminal 3 include a tablet computer, a personal computer, and the like. A web browser, an e-mail client, and the like may be installed in the golf course terminal 3. The golf course terminal 3 transmits a request to the golf course reservation server 1 based on an operation by the employee, and displays information such as a web page transmitted from the golf course reservation server 1 in response to the request. The employee checks reservations for the golf course and the like by using the golf course terminal 3.

Each user terminal 4 is a terminal device used by a user who reserves a golf course by using the reservation site. Examples of the user terminal 4 include a personal computer, a smartphone, a portable information terminal such as a tablet computer, a mobile phone, a personal digital assistant (PDA), a set-top box, and the like. Software such as a browser and an e-mail client may be installed in the user terminal 4. Furthermore, in a case where the user terminal 4 is a portable terminal device, a dedicated application for using the reservation site may be installed in the user terminal 4.

### [1-2. Configuration of Golf Course Reservation Server]

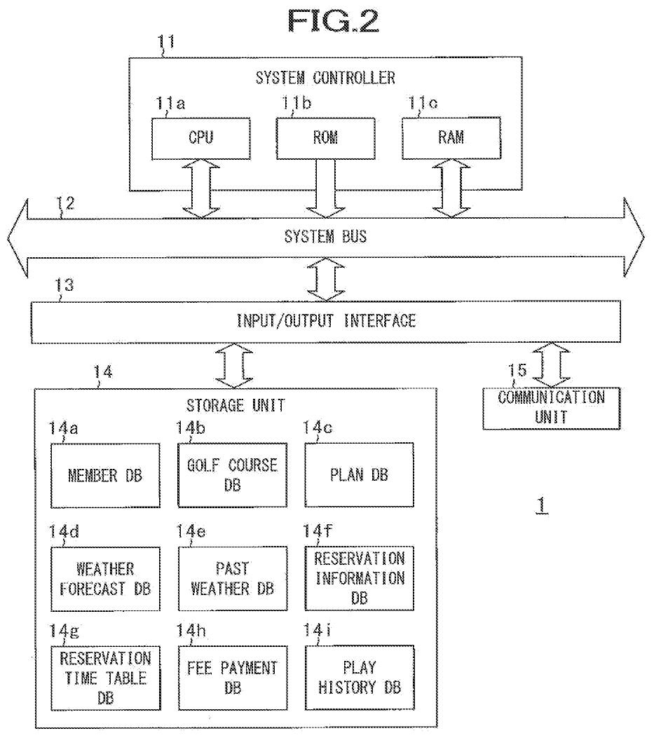

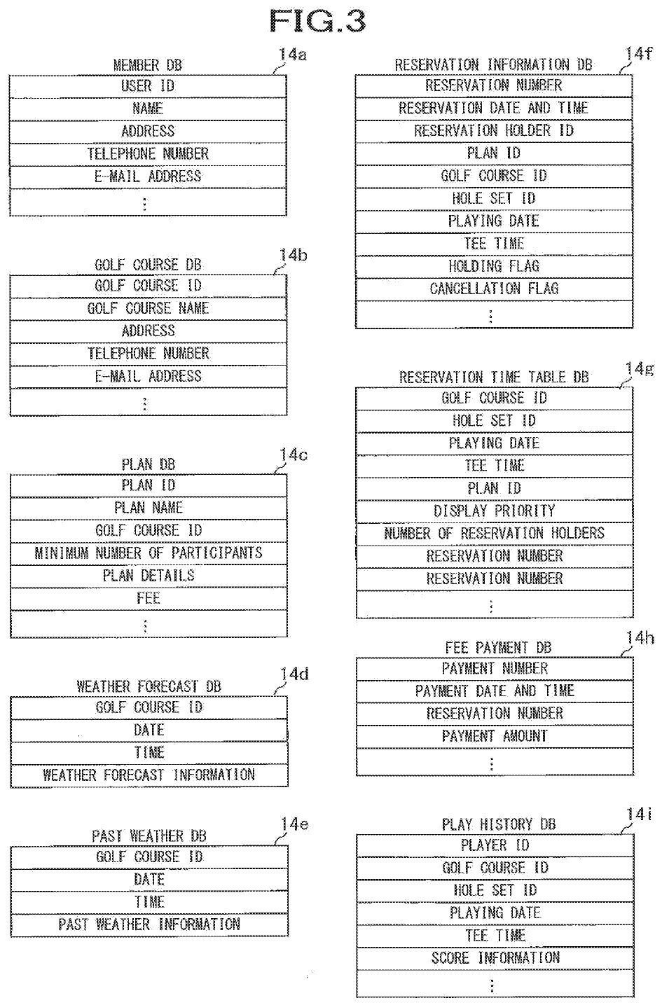

Next, a configuration of the golf course reservation server 1 will be described with reference to FIGS. 2 and 3. FIG. 2 is a block diagram illustrating an example of a schematic configuration of the golf course reservation server 1 according to the present embodiment. As illustrated in FIG. 2, the golf course reservation server 1 includes a system controller 11, a system bus 12, an input/output interface 13, a storage unit 14, and a communication unit 15. The system controller 11 and the input/output interface 13 are connected via the system bus 12.

The system controller 11 includes a central processing unit (CPU) 11a, a read only memory (ROM) 11b, a random access memory (RAM) 11c, and the like.

The input/output interface 13 executes interface processing between the storage unit 14 and the communication unit 15, and the system controller 11.

The storage unit 14 is implemented by, for example, a hard disk drive or the like. The storage unit 14 stores databases such as a member DB 14a, a golf course DB 14b, a plan DB 14c, a weather forecast DB 14d, a past weather DB 14e, a reservation information DB 14f, a reservation time table DB 14g, a fee payment DB 14h, and a play history DB 14i. The “DB” is an abbreviation for database. FIG. 3 is a diagram illustrating an example of information stored in the databases.

The member DB 14a stores member information regarding a user who uses the golf course reservation system S for each user. Specifically, the member DB 14a stores, as the member information, a user ID, a name, an address, a telephone number, an e-mail address, and the like in association with one another. The user ID is identification information for identifying a user.

The golf course DB 14b stores golf course information regarding a golf course that can be reserved using the golf course reservation system S for each golf course. Specifically, the golf course DB 14b stores, as the golf course information, a golf course ID, a golf course name, an address, a telephone number, an e-mail address, and the like in association with one another. The golf course ID is identification information for identifying a golf course.

The plan DB 14c stores plan information regarding a single person reservation plan that can be reserved using the golf course reservation system S stored for each plan. Specifically, the plan DB 14c stores, as the plan information, a plan ID, a plan name, a golf course ID, the minimum number of participants, plan details, a fee, and the like in association with one another. The plan ID is identification information for identifying a plan. The golf course ID indicates a golf course that provides the plan. The minimum number of participants indicates the minimum number of reservation holders required to hold an event of golf.

The weather forecast DB 14d stores weather forecast information indicating at least weather predicted in the latest weather forecast for each combination of a golf course, a date, and a period of time. Specifically, the weather forecast DB 14d stores a golf course ID, a date, a time, and the weather forecast information in association with one another. The golf course ID indicates the golf course. The time indicates a start time of the period of time. The length of the period of time may be, for example, 10 minutes, one hour, four hours, one day, or the like. The golf course reservation server 1 transmits position information of the golf course and the corresponding date and time to the weather information provision server 2, thereby acquiring the weather forecast information of the date and time in the golf course. Then, the golf course reservation server 1 stores the acquired weather forecast information in the weather forecast DB 14d in association with the golf course ID of the golf course, the date, and the time. The weather forecast DB 14d may also store information on weather predicted in a past weather forecast.

The past weather DB 14e stores past weather information indicating the past weather for each combination of a golf course, a date, and a period of time. Specifically, the past weather DB 14e stores a golf course ID, a date, a time, and the past weather information in association with one another. The golf course ID indicates the golf course. The time indicates a start time of the period of time. The golf course reservation server 1 transmits position information of the golf course and the corresponding date and time to the weather information provision server 2, thereby acquiring the past weather information of the date and time in the golf course. Then, the golf course reservation server 1 stores the acquired past weather information in the past weather DB 14e in association with the golf course ID of the golf course, the date, and the time.

The reservation information DB 14f stores reservation information regarding reservation of a golf course each time reservation is made. Specifically, the reservation information DB 14f stores, as the reservation information, a reservation number, a reservation date and time, a reservation holder ID, a plan ID, a golf course ID, a hole set ID, a playing date, a tee time, a holding flag, a cancellation flag, and the like in association with one another. The reservation number is a number for identifying the reservation. The reservation holder ID is a user ID of a user who has made the reservation. The plan ID indicates a reserved plan. The golf course ID indicates a reserved golf course. The hole set ID is identification information for identifying a reserved set of nine holes. The playing date and the tee time indicate a date and time when reserved golf play is performed. The holding flag indicates whether or not an event of golf is determined to be held in a reserved playing frame. The holding flag that is set to “undecided” indicates that the event of golf is not determined to be held or not to be held. The holding flag that is set to “hold” indicates that the event of golf is to be held because the number of reservation holders has reached the minimum number of participants. The holding flag that is set to “not held” indicates that the event of golf is not held because the number of reservation holders is less than the minimum number of participants. The cancellation flag indicates whether or not the reservation has been canceled by the reservation holder.

The reservation time table DB 14g stores reservation state information indicating a reservation state of a golf course for each playing frame. Specifically, the reservation time table DB 14g stores, as the reservation state information, a golf course ID, a hole set ID, a playing date, a tee time, a plan ID, a display priority, and the number of reservation holders in association with one another. The golf course ID, the hole set ID, the playing date, and the tee time indicate the playing frame. The plan ID indicates a plan that can be reserved for the target playing frame. The display priority indicates how much priority is given to display of information regarding the target playing frame when the information regarding the target playing frame is provided to the user terminal 4. For example, the display priority may be indicated by a numerical value. The higher the numerical value is, the higher the priority of display may be. The number of reservation holders indicates the number of users who have reservations for the playing frame at the present time. The number of reservation holders corresponds to the number of members of a group at the present time. In a case where the number of reservation holders is one or more, the reservation time table DB 14g further stores reservation numbers corresponding to the number of reservation holders. Each reservation number corresponds to the reservation information of a user who has reserved the playing frame. The golf course reservation server 1 updates the reservation state information each time reservation is made or canceled. For example, when a reservation is made, the golf course reservation server 1 increases the number of reservation holders by one and stores a reservation number corresponding to the reservation in the reservation time table DB 14g. On the other hand, when a reservation is canceled, the golf course reservation server 1 decreases the number of reservation holders by one and deletes a reservation number corresponding to the canceled reservation from the reservation time table DB 14g.

The fee payment DB 14h stores payment information indicating payment of a usage fee of a golf course by a reservation holder of the golf course for each usage fee payment. Specifically, the fee payment DB 14h stores, as the payment information, a payment number, a payment date and time, a reservation number, a payment amount, and the like in association with one another. The payment number is a number for identifying payment. The reservation number indicates a reservation for which the usage fee has been paid. The reservation holder of the golf course goes to the reserved golf course and checks in on a reserved playing date. The check-in is a procedure for starting use of the golf course. After the check-in, the reservation holder plays golf with the other reservation holders. Once the golf play ends, the reservation holder checks out. The check-out is a procedure for ending use of the golf course. The reservation holder pays the usage fee, for example, at the time of the check-in or check-out. The employee of the golf course selects reservation made by the reservation holder by operating the golf course terminal 3, and inputs the fact that the fee has been paid. In response to this input, the golf course terminal 3 transmits a payment notification including a reservation number corresponding to the selected reservation to the golf course reservation server 1. The golf course reservation server 1 stores, in the fee payment DB 14h, the payment information including the reservation number in the payment notification.

The play history DB 14i stores a history of golf play by a user who uses the golf course reservation system S. Specifically, the play history DB 14i stores, as a play log, a player ID, a golf course ID, a hole set ID, a playing date, a tee time, score information, and the like for each play in association with one another. The player ID is a user ID of a user who has played golf. The golf course ID, the hole set ID, the playing date, and the tee time indicate a golf course, a set of nine holes, a playing date, and a tee time of a playing frame at which the user has played golf, respectively. The score information is information indicating a score of the user in the target play. For example, when a user reserves a certain playing frame and then the reservation is not canceled until a playing date, the golf course reservation server 1 may store a new play log in the play history DB 14i. At this time, for example, the golf course reservation server 1 may acquire the reservation holder ID, the golf course ID, the hole set ID, the playing date, and the tee time from the reservation information of the target reservation, and generate the play log based on these pieces of information. Alternatively, the golf course reservation server 1 may store a new play log in the play history DB 14i when a user who has made a reservation checks in to the golf course. For example, the employee of the golf course inputs, to the golf course terminal 3, a name, a user ID, and the like of the user who checks in. The golf course reservation server 1 searches the reservation information DB 14f for reservation information corresponding to the reservation made by the user who checks in, based on the input information. At this time, the golf course reservation server 1 determines to permit the check-in only in a case where the target reservation has not been canceled. Once it is determined to permit the check-in, the golf course reservation server 1 stores the play log. After the play log is stored, when the user selects the target play log and inputs the score information by operating the user terminal 4, the golf course reservation server 1 may store the score information in the play history DB 14i in association with the selected play log.

The storage unit 14 further stores various programs such as an operating system, a database management system (DBMS), and a server program. The server program is a program for causing the system controller 11 to execute processing related to golf course usage reservation, processing related to content distribution, and the like. For example, the server program may be acquired from another device via the network NW, or may be recorded in a recording medium such as a magnetic tape, an optical disk, or a memory card and read via a drive device.

The communication unit 15 is implemented by, for example, a network interface card or the like. The communication unit 15 is connected to the weather information provision server 2, the golf course terminal 3, the user terminal 4, and the like via the network NW, and controls a state of communication with these devices.

### [1-3. Overview of Functions of System Controller]

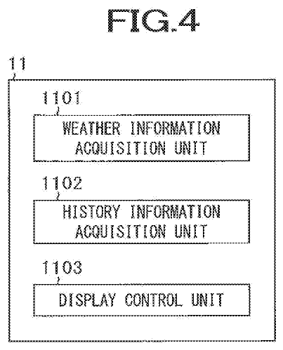

Next, an overview of functions of the system controller 11 in the golf course reservation server 1 will be described with reference to FIGS. 4 to 7. FIG. 4 is a diagram illustrating an example of functional blocks of the system controller 11 in the golf course reservation server 1 according to the present embodiment. The system controller 11 functions as a weather information acquisition unit 1101, a history information acquisition unit 1102, a display control unit 1103, and the like as illustrated in FIG. 4 by the CPU 11a reading and executing various program codes included in the server program.

The weather information acquisition unit 1101 acquires weather information indicating weather at each of future playing frames of future playing times. The future playing frame is a playing frame of a future playing time. The weather indicated by the weather information is weather of at least one golf course in which single person reservation is available. The weather corresponding to the future playing frame is weather in the playing time in the golf course of the playing frame and is predicted weather. For example, the weather information acquisition unit 1101 may acquire the weather forecast information stored in the weather forecast DB 14d.

The history information acquisition unit 1102 acquires history information indicating logs on whether any of reservation holders who each have a reservation for a future playing frame canceled a reservation for bat weather past playing frames among past playing frames reserved by these reservation holders. The past playing frame is a playing frame of a past playing time. The bad weather past playing frame is a playing frame of a past playing time at which the weather is predetermined weather. The predetermined weather is weather that possibly has a negative impact on playing golf. The weather at the playing frame of the past playing time may be actual weather at the playing time in the golf course of the playing frame or predicted weather for the playing time. The negative impact on playing golf may be, for example, making it difficult to play golf, making it difficult to get a normal score or a good score, or making the physical condition of the user who plays golf worse. The predetermined weather that possibly has a negative impact on playing golf may be, for example, at least one of rainy weather, strong wind, excessively high temperature, and excessively low temperature. Rain may, for example, obstruct the field of vision of a player, wet the body of the player and the ground, which makes it difficult to play golf, or may cool the body of the player, which makes it difficult to move. The wind may, for example, change the trajectory of a shot ball beyond the player's expectation or cause the player's posture to collapse. The excessively high temperature may, for example, raise the body temperature of the player, which lowers the concentration of the player or makes the physical condition of the player worse. The low temperature may, for example, lower the body temperature of the player, which makes it difficult for the body of the player to move or makes the physical condition of the player worse. Specifically, the predetermined weather may be at least one of a precipitation amount of a predetermined amount or more, a wind speed of a predetermined speed or higher, a temperature of a first predetermined temperature or higher (for example, 35 degrees Celsius or higher), and a temperature of a second predetermined temperature or lower (for example, 0 degrees Celsius or less). The predetermined weather is referred to as bad weather for convenience. Weather other than the predetermined weather is referred to as good weather for convenience. In the present embodiment, even in a case where the weather is fine and there is no wind, the weather may be classified as bad weather depending on the temperature. The history information acquisition unit 1102 may determine whether or not the weather is bad weather or good weather based on the past weather DB 14e. Alternatively, the history information acquisition unit 1102 may determine whether or not the weather is bad weather or good weather based on weather forecast information regarding predicted weather at the past playing time among the weather forecast information stored in the weather forecast DB 14d.

Examples of the history information indicating the logs on the cancellation states include the reservation information stored in the reservation information DB 14f, the payment information stored in the fee payment DB 14h, and the play log stored in the play history DB 14i. The reservation information stored in the reservation information DB 14f indicates a history of reservation of the golf course made by each user. The reservation information includes a cancellation flag. Therefore, the reservation information also indicates a history of whether or not the user has canceled the reservation. In a case where the user has not canceled the reservation, there is a high possibility that the user has played golf in the target playing frame. On the other hand, in a case where the user has canceled the reservation, it is considered that the user has not played golf in the target playing frame. The payment information stored in the fee payment DB 14h indicates a history of usage fee payment by each user. As described above, the usage fee of the golf course is paid at the time of check-in or check-out at the golf course. Therefore, the payment of the usage fee indicates that the user has visited the reserved golf course, and indicates that the user has not canceled the reservation. From the fact that the user has visited the reserved golf course and has paid the usage fee, it is considered that the user has played golf at the golf course. Meanwhile, in a case where the information on the payment of the usage fee for the target playing frame is not stored in the fee payment DB 14h even though the reservation information indicates that the user has reserved the golf course, such a fact indicates that the user has not played golf and also indicates that there is a probability that the user has canceled the reservation. Therefore, it is possible to identify the cancellation state of reservation by combining the reservation information and the payment information. The play log is stored in a case where the reservation has not been canceled after the user reserves the playing frame. Therefore, the play log indicates a history of the reservation that has not been canceled by the user. Therefore, it is possible to identify the cancellation state of reservation by combining the reservation information and the play log.

The display control unit 1103 controls, based on the history information acquired by the history information acquisition unit 1102, display priorities of information on bad weather future playing frames among the playing frames of the future playing times. The bad weather future playing frame is a future playing frame at which the weather indicated by the weather information acquired by the weather information acquisition unit 1101 is bad weather. The bad weather in this case may be at least anyone of a precipitation percentage of a predetermined probability or higher, a predicted precipitation amount of a predetermined amount or more, a predicted wind speed of a predetermined speed or higher, a predicted temperature of the first predetermined temperature or higher, or a predicted temperature of the second predetermined temperature or lower. The information on the playing frame to be displayed is referred to as playing frame information. The playing frame information may be, for example, information on each playing frame in the list of playing frames included in the search result page, the front page for the single person reservation plan, or the like. The display priority may indicate, for example, how much the information on the target playing frame is preferentially displayed. Alternatively, the display priority may indicate a position where the information on the target playing frame is displayed among a plurality of positions where a plurality of playing frames are to be displayed. Alternatively, the display priority may indicate how much the information on the target playing frame is highlighted among the plurality of playing frames. The display control unit 1103 may directly determine the display priority. For example, the display control unit 1103 may determine an absolute display priority or may determine a relative display priority. Examples of the relative display priority include a display rank. The display rank indicates the position where the information on the target playing frame is displayed in the list of playing frames. The higher the display rank, the higher the display priority. The display control unit 1103 may indirectly determine the display priority. For example, the display control unit 1103 may indirectly determine the display priority as a result of rearranging a plurality of playing frames based on which playing frame is prioritized over which playing frame.

The display control unit 1103 may determine, based on the history information, degrees of tendency of the reservation holders who have reserved playing frames of future playing times at which bad weather is expected to cancel reservation for a bad weather playing frame. The bad weather playing frame is a playing frame at which the weather is bad weather. Then, the display control unit 1103 may set the display priority of information on a bad weather future playing frame that has been reserved by a reservation holder whose degree of tendency to cancel reservation for a bat weather playing frame is lower than a predetermined degree to be higher than the display priority of information on a bad weather future playing frame that has reserved by a reservation holder whose degree of tendency to cancel reservation for a bat weather playing frame is equal to or higher than the predetermined degree. The bad weather future playing frame is a playing frame of a future playing time at which the weather is bad weather. For example, there may be a reservation holder who cancels reservation once they knows that the weather forecast has been changed from good weather to bad weather. The reason is that, as described above, it is difficult to play golf, it is difficult to get a good score, or the physical condition becomes worse. It is assumed that a user selects one of the playing frames from the list of playing frames and makes a reservation. In a case where the number of reservation holders is equal to or more than the minimum number of participants when the reservation has made, the user expects that the event of golf will be held. However, in a case where another user who has previously made the reservation cancels the reservation for the playing frame and thereby the number of reservation holders becomes less than the minimum number of participants, it is determined that the event of golf will not be held at the reserved playing frame, and the reservations of all the reservation holders are automatically canceled. In this case, expectations of the users are not realized. Therefore, display of information on a playing frame reserved by a user having a low degree of tendency to cancel reservation of bad weather playing frame is prioritized over other playing frames of the future playing times at which bad weather is expected. It enables a user who views the list of playing frames to easily select a playing frame whose possibility of cancellation of the reservation is relatively low. That is, the user easily selects the playing frame of which the number of reservation holders is less likely to fall below the minimum number of participants. By doing so, it is possible to realize the expectations of the users who make reservations later. The degree of tendency to cancel reservation of bad weather playing frame may be indicated by, for example, a bad weather cancellation rate. The bad weather cancellation rate is a proportion of playing frames at which the user played golf among bad weather playing frames reserved by the user. The predetermined degree may be, for example, 50%.

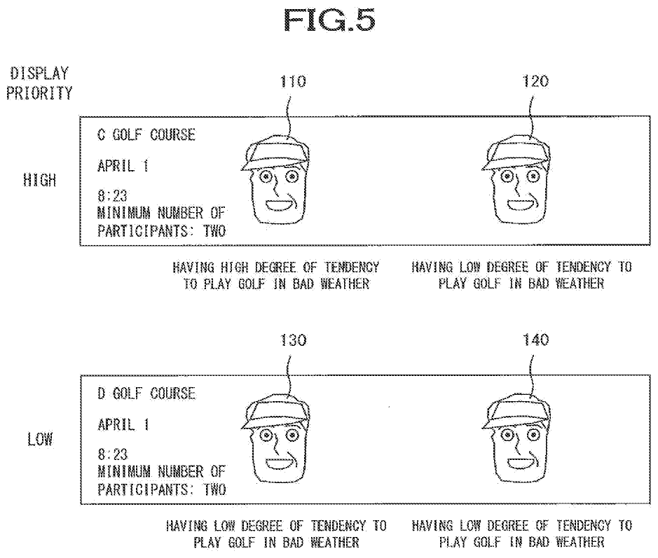

More specifically, the display control unit 1103 may set the display priority of information on a first bad weather future playing frame to be higher than the display priority of information on a second bad weather future playing frame. The first and second bad weather future playing frame are bad weather future playing frame. The first bad weather future playing frame has been reserved by reservation holders including persons whose degrees of tendency to cancel reservation for the bad weather playing frame are lower than the predetermined degree and the number of these persons is equal to or more than a reference number. The reference number is one less than the minimum number of participants. The number of reservation holders who have reserved the second bad weather future playing frame is equal to or more than the reference number. The number of persons, among these reservation holders, whose degrees of tendency to cancel the reservation for the bad weather playing frame are lower than the predetermined degree is less than the reference number. The condition that the number of reservation holders whose degrees of tendency to cancel reservation for a bad weather playing frame is lower than the predetermined degree is equal to or more than the reference number indicates the following situation. Even in a case where all the reservation holders whose degrees of tendency to cancel reservation for the bad weather playing frame is equal to or higher than the predetermined degree has canceled the reservations, the number of remaining reservation holders does not fall below the minimum number of participants or the number of reservation holders becomes equal to or more than the minimum number of participants if a user to whom the playing frame information is presented makes a reservation. Therefore, the event of golf is more likely to be held at a playing frame that satisfies this condition than at a playing frame that does not satisfy this condition. FIG. 5 is a diagram illustrating an example of determining the display priority. As illustrated in FIG. 5, in each of a C golf course and a D golf course, there are two reservation holders for playing date and the same tee time. In each of the C golf course and the D golf course, weather on the playing date and the tee time is expected to be bad weather. The minimum number of participants of each of the C golf course and the D golf course is two. Therefore, in a case of determining only from the number of reservation holders at the present time, the event of golf is expected to be held at the playing frame of each of the C golf course and the D golf course. Users 110 and 120 have made reservations for the C golf course. The user 110 is a user who has a low degree of tendency to cancel reservation of a bad weather playing frame. The user 120 is a user who has a high degree of tendency to cancel reservation of a bad weather playing frame. Therefore, the user 110 is likely not to cancel the reservation to the end, and thus, at least one reservation holder is expected to remain. If this state is maintained, the number of reservation holders is one less than the minimum number of participants, and thus the event of golf is not held. However, if a user who is viewing the list of playing frames selects the C golf course and makes a reservation, the number of reservation holders is two, and it is expected that the event of golf will be held. Meanwhile, users 130 and 140 have made reservations for the D golf course. Both the users 130 and 140 are users who have high degrees of tendency to cancel reservation of a bad weather playing frame. Therefore, these users are likely to cancel the reservation, and thus, there is a possibility that the number of reservation holders is zero. At this time, even if the user who is viewing the list of playing frames selects the D golf course and makes a reservation, the number of reservation holders is only one and is less than the minimum number of participants. Therefore, the display control unit 1103 may set the display priority of information on the C golf course to be higher than the display priority of information on the D golf course.

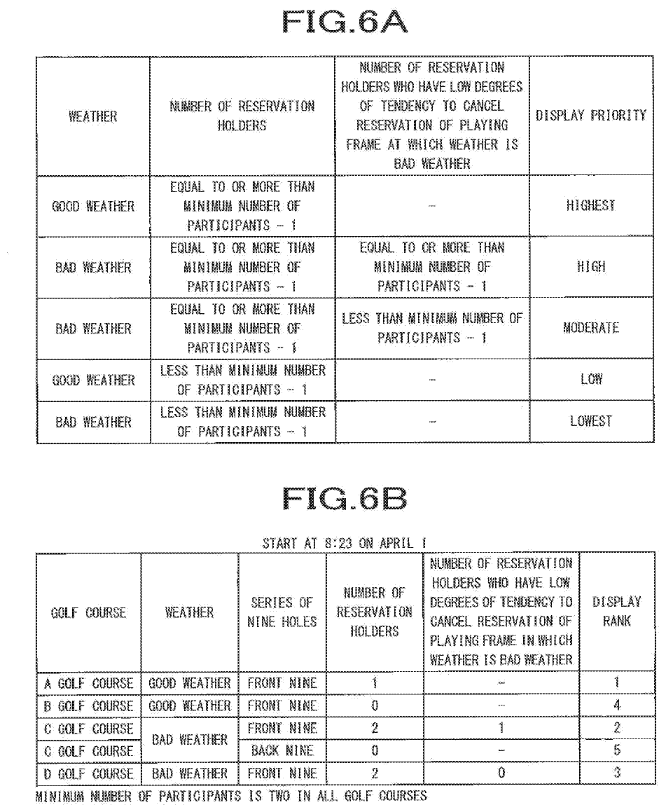

The list of playing frames generally includes a playing frame in which good weather is expected as well as a playing frame in which bad weather is expected. The display control unit 1103 may determine the display priority of information on each of the playing frames including the playing frame at which good weather is expected. For example, the display control unit 1103 may set the display priority to be higher as the possibility that the event of golf is held is higher. FIG. 6A is a diagram illustrating an example of a relationship between a combination of the weather and the number of reservation holders and the display priority. For example, the display control unit 1103 may set the highest display priority for a playing frame satisfying all of two conditions. A first condition is that good weather is expected. A second condition is that the number of reservation holders is equal to or more than the reference number. As described above, such a playing frame is a playing frame at which the event of golf is expected to be held based on the number of reservation holders at the present time. In addition, there is a lower possibility that the reservation holder cancels the reservation of the playing frame at which good weather is expected. The display control unit 1103 may set the second highest display priority for a playing frame satisfying all of three conditions. A first condition is that bad weather is expected. A second condition is the number of reservation holders is equal to or more than the reference number. A third condition is the number of persons, among the reservation holders, who have lower degrees of tendency to cancel reservation of the bad weather playing frame is equal to or more than the reference number. The event of golf is expected to be held in consideration of only the number of reservation holders at the present time. However, a possibility that the reservation for such a playing frame is canceled by the reservation holder is higher than that for the playing frame with the first highest priority, at which good weather is expected. The display control unit 1103 may set the third highest display priority for a playing frame satisfying all of three conditions. A first condition is that bad weather is expected. A second condition is that the number of reservation holders is equal to or more than the reference number. The third condition is that the number of persons, among the reservation holders, who have lower degrees of tendency to cancel reservation of the bad weather playing frame is less than the reference number. The event of golf is expected to be held in consideration of only the number of reservation holders at the present time. However, a possibility that the number of reservation holders falls below the minimum number of participants is higher than that for the playing frame with second highest priority. The display control unit 1103 may set the fourth highest display priority for a playing frame satisfying all of two conditions. A first condition is that good weather is expected. A second condition is that the number of reservation holders is less than the reference number. Even in a case where a user who views the list of playing frames reserves the playing frame, the number of reservation holders is less than the minimum number of participants. Therefore, it is not expected at the present to hold the event of golf time even in consideration of the number of reservation holders. The display control unit 1103 may set the lowest display priority for a playing frame satisfying all of two conditions. A first condition is that bad weather is expected. A second condition is that the number of reservation holders is less than the reference number. Even in a case where the user who views the list of playing frames reserves the playing frame, the number of reservation holders is less than the minimum number of participants. Furthermore, a possibility that the number of reservation holders is decreased in the future is higher than that for the playing frame with the fourth highest priority.

FIG. 6B is a diagram illustrating a specific example of determining the display priority. It is assumed that there are five playing frames whose tee time is 8:23 in the list of playing frames whose playing date is April 1. A first playing frame is front nine of an A golf course. Good weather is expected, and the current number of reservation holders is one. A second playing frame is front nine of a B golf course. Good weather is expected, and the current number of reservation holders is zero. A third playing frame is front nine of a C golf course. Bad weather is expected, and the current number of reservation holders is two. The reservation holders include one reservation holder that has lower tendency to cancel reservation of the bad weather playing frame. A fourth playing frame is back nine of the C golf course. Bad weather is expected, and the current number of reservation holders is zero. A fifth playing frame is front nine of a D golf course. Bad weather is expected, and the current number of reservation holders is two. The reservation holders does not include any reservation holder that has lower tendency to cancel reservation of the bad weather playing frame. In any golf course, the minimum number of participants is two. In a case of determining a display rank of these playing frames, the first playing frame is displayed at the uppermost position because good weather is expected and the number of reservation holders is equal to or more than the reference number. The third playing frame is displayed at the second uppermost position because bad weather is predicted and the number of reservation holders who have low degrees of tendency to cancel reservation of a bad weather playing frame is equal to or more than the reference number. The fifth playing frame is displayed at the third uppermost position because bad weather is expected, the number of reservation holders is equal to or more than the reference number and the number of reservation holders who have low degrees of tendency to cancel reservation of a bad weather playing frame is less than the reference number. The second playing frame is displayed at the fourth uppermost position because good weather is expected and the number of reservation holders is less than the reference number. The fourth playing frame is displayed at the fifth uppermost position because bad weather is expected and the number of reservation holders is less than the reference number.

The display control unit 1103 causes the user terminal 4 to display the list of playing frames according to the display priority determined based on the history information. For example, the display control unit 1103 may determine the display rank of each piece of the playing frame information based on the display priority. Next, the display control unit 1103 may sort and display the playing frame information according to the display rank. Here, the list of playing frames may be sorted according to any sort condition different from the display priority. Examples of the sort condition include an order from the earliest playing date and tee time, an order from the lowest usage fee, an order from the highest evaluation of the golf course from users, and an order from a golf course with the largest number of reservations within a predetermined period. A value used for sorting is referred to as a sort value. For example, the sort value may be a combination of a playing date and a tee time, a usage fee, an evaluation value, or the number of reservations. The display control unit 1103 may sort the playing frames according to the sort condition first. Next, if there are playing frames having the same sort value, the display control unit 1103 may determine the display rank of these playing frames according to the display priority based on the weather information and the history information. Alternatively, a descending order of a possibility that the event of golf is held may be designated as the sort condition. In a case of this sort condition, the display control unit 1103 may sort the playing frames according to the priority described with reference to FIGS. 6A and 6B.

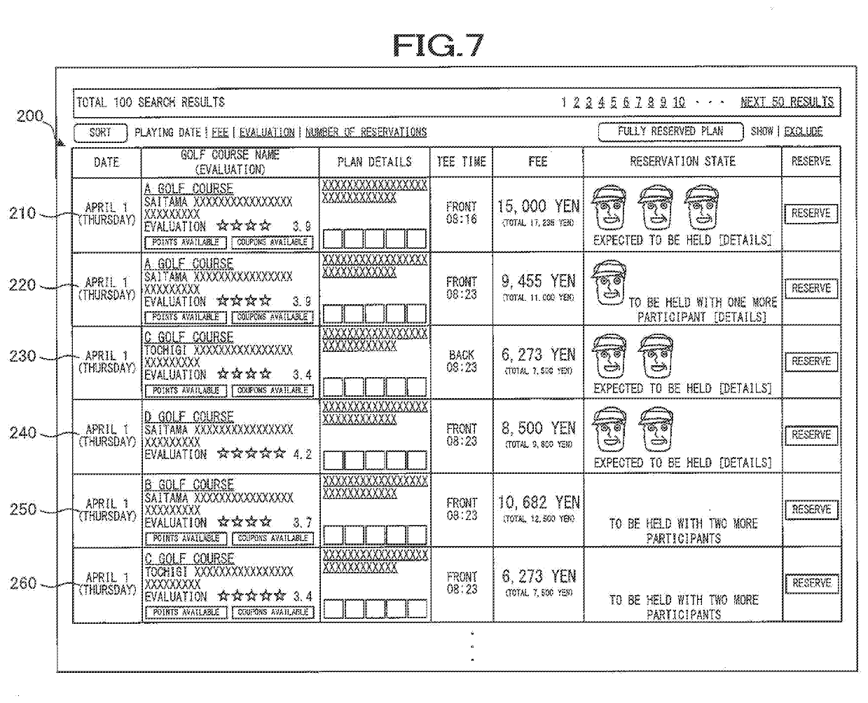

FIG. 7 is a diagram illustrating an example of display of the list of playing frames. As illustrated in FIG. 7, for example, a playing frame list 200 is displayed on the search result page or the front page for the single person reservation. The playing frame list 200 includes pieces of playing frame information 210, 220, 230, 240, 250, 260, and the like. Each piece of playing frame information may include, for example, a playing date, a name of a golf course, an address of the golf course, an evaluation, plan details, a name of a set of nine holes, a tee time, a usage fee, a reservation state, a reservation button, and the like. The reservation state may indicate, for example, the current number of reservation holders and/or an overview of users who have made a reservation at the present time. when the user presses the reservation button, the user terminal 4 displays detailed information on the selected playing frame and information on the reservation holders. Here, if the user performs an operation of proceeding with a reservation procedure, the user terminal 4 displays the reservation details. Here, if the user performs an operation of confirming the reservation, the target playing frame is reserved. In FIG. 7, each of pieces of playing frame information corresponds to a playing frame whose playing date is April 1. The pieces of playing frame information 210 to 260 are arranged in order from the earliest tee time. Specifically, the pieces of playing frame information 210, 220, 230, 240, 250, and 260 are displayed in this order. The playing frame information 210 is information on a playing frame whose tee time is 8:16. Each piece of the playing frame information 220 to 260 is information on a playing frame whose tee time is 8:23. For example, the pieces of playing frame information 220 to 260 are displayed according to the display rank as illustrated in FIG. 6B.

The display control unit 1103 may display the playing frame information in an appearance corresponding to the display priority. Examples of the appearance include the size of the playing frame information, the size of characters in the playing frame information, the color of the playing frame information or the character, and the like. The display control unit 1103 may display the playing frame information in a more conspicuous manner as the display priority is higher. For example, the display control unit 1103 may increase the size of the playing frame information, increase the size of characters, or increase the contrast in the playing frame information or the contrast between the playing frame information and the outside thereof as the display priority is higher.

### [1-4. Operation of Golf Course Reservation Server]

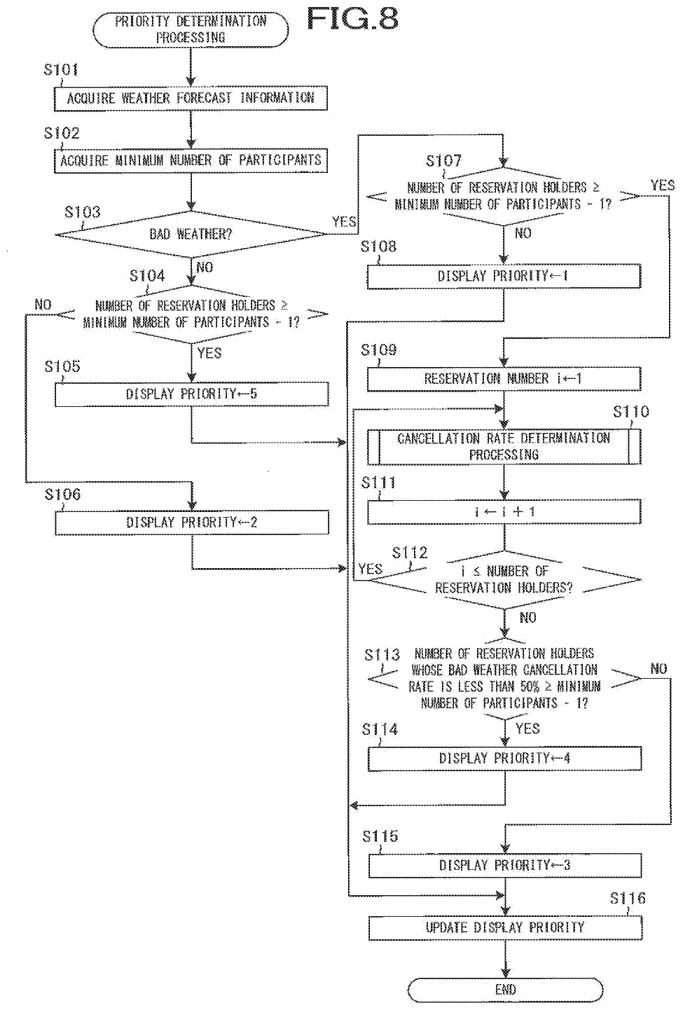

Next, an operation of the golf course reservation server 1 will be described with reference to FIGS. 8 to 10. The system controller 11 of the golf course reservation server 1 executes processing illustrated in FIGS. 8 to 10 according to various program codes included in the server program.

FIG. 8 is a flowchart illustrating an example of priority determination processing performed by the system controller 11 of the golf course reservation server 1. The system controller 11 periodically updates the weather forecast information in the weather forecast DB 14d, for example. The system controller 11 may execute the priority determination processing for each playing frame whose tee time is included in a date and a period of time of the updated weather forecast information among playing frames of a golf course corresponding to the updated weather forecast information. In addition, the system controller 11 may execute the priority determination processing for a playing frame of which the number of reservation holders has been changed due to a user making a reservation or canceling a reservation.

As illustrated in FIG. 8, first, the weather information acquisition unit 1101 weather forecast information having the golf course ID, the date and the period of time corresponding to the golf course ID, the playing date and tee time of the target playing frame from the weather forecast DB 14d (Step S101). Next, the display control unit 1103 acquires the minimum number of participants of the target playing frame (Step S102). For example, the display control unit 1103 acquires a plan ID, the number of reservation holders, and reservation numbers associated with a combination of the golf course ID of the target playing frame, the playing date, and the tee time from the reservation time table DB 14g. The display control unit 1103 acquires the minimum number of participants associated with the acquired plan ID from the plan DB 14c.

Next, the history information acquisition unit 1102 determines whether or not the predicted weather is bad weather based on the acquired weather forecast information (Step S103). For example, the history information acquisition unit 1102 may determine whether or not the precipitation percentage is equal to or higher than the predetermined probability, whether or not the wind speed is equal to or higher than the predetermined speed, whether or not the temperature is equal to or higher than the first predetermined temperature, and whether or not the temperature is equal to or lower than the second predetermined temperature. In a case where the weather is not bad weather (Step S103: NO), the display control unit 1103 determines whether or not the number of reservation holders of the target playing frame is equal to or more than “the minimum number of participants−1” (Step S104). In a case where the number of reservation holders is equal to or more than “the minimum number of participants−1” (Step S104: YES), the display control unit 1103 determines the display priority to be 5 (Step S105). On the other hand, in a case where the number of reservation holders is not equal to or more than “the minimum number of participants−1” (Step S104: NO), the display control unit 1103 determines the display priority to be 2 (Step S106).

In a case where the predicted weather is bad weather (Step S103: YES), the display control unit 1103 determines whether or not the number of reservation holders of the target playing frame is equal to or more than “the minimum number of participants−1” (Step S107). In a case where the number of reservation holders is not equal to or more than “the minimum number of participants−1” (Step S107: NO), the display control unit 1103 determines the display priority to be 1 (Step S108). On the other hand, in a case where the number of reservation holders is equal to or more than “the minimum number of participants−1” (Step S107: YES), the display control unit 1103 sets a reservation holder number i to 1(Step S109). Next, the display control unit 1103 executes cancellation rate determination processing (Step S110).

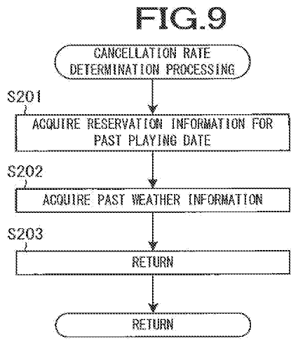

FIG. 9 is a flowchart illustrating an example of cancellation rate determination performed by the system controller 11 of the golf course reservation server 1. As illustrated in FIG. 9, the history information acquisition unit 1102 acquires the reservation information of the i-th reservation holder for the past playing date from the reservation information DB 14f (Step S201). For example, the history information acquisition unit 1102 acquires, from the reservation information DB 14f, the reservation information associated with the i-th reservation number among the reservation numbers acquired from the reservation time table DB 14g in Step S102 of the priority determination processing. The history information acquisition unit 1102 acquires a reservation holder ID of the i-th reservation holder from the reservation information. The history information acquisition unit 1102 acquires, from the reservation information DB 14f, all pieces of reservation information for a playing date before yesterday among the pieces of reservation information associated with the reservation holder ID.

Next, the weather information acquisition unit 1101 acquires the past weather information regarding the playing frame reserved by the i-th reservation holder from the past weather DB 14e (Step S202). For example, the weather information acquisition unit 1101 acquires the golf course ID, the playing date, and the tee time from each reservation information acquired in Step S201. The weather information acquisition unit 1101 acquires the past weather information associated with the acquired golf course ID, the date, and the period of time corresponding to the acquired golf course ID, the playing date and the tee time.

Next, the display control unit 1103 calculates a bad weather cancellation rate of the i-th reservation holder based on the acquired reservation information and past weather information (Step S203). For example, the display control unit 1103 determines whether or not the weather corresponding to the past playing frame reserved by the i-th reservation holder is bad weather based on the reservation information and the past weather information. For example, the display control unit 1103 may determine whether or not the precipitation amount is equal to or more than the predetermined amount, whether or not the wind speed is equal to or higher than the predetermined speed, whether or not the temperature is equal to or higher than the first predetermined temperature, and whether or not the temperature is equal to or lower than the second predetermined temperature. Then, the display control unit 1103 identifies a playing frame at which the weather was bad weather and counts the number of reservations thereof. The display control unit 1103 counts the number of reservations canceled by the i-th reservation holder based on the cancellation flag of the reservation information of each playing frame at which the weather was bad weather. Finally, the display control unit 1103 calculates the bad weather cancellation rate by dividing the number of canceled reservations by the number of reservations at which the weather was bad weather, and the cancellation rate determination processing ends.

Returning to FIG. 8, after the cancellation rate determination processing, the display control unit 1103 increases the reservation holder number i by 1 (Step S111). Next, the display control unit 1103 determines whether or not the reservation holder number i is equal to or less than the number of reservation holders acquired in Step S102 (Step S112). In a case where the reservation holder number i is equal to or less than the number of reservation holders (Step S112: YES), the processing proceeds to Step S110. On the other hand, in a case where the reservation holder number i is not equal to or less than the number of reservation holders (Step S112: NO), the display control unit 1103 determines whether or not the number of reservation holders whose bad weather cancellation rate is less than 50% among the reservation holders of the target playing frame is equal to or more than “the minimum number of participants−1” (Step S113). In a case where the number of reservation holders whose bad weather cancellation rate is less than 50% is equal to or more than “the minimum number of participants−1” (Step S113: YES), the display control unit 1103 determines the display priority to be 4 (Step S114). On the other hand, in a case where the number of reservation holders whose bad weather cancellation rate is less than 50% is not equal to or more than “the minimum number of participants−1” (Step S113: NO), the display control unit 1103 determines the display priority to be 3 (Step S115).

When the display priority is determined (Step S105, S106, S108, S114, or S115), the display control unit 1103 updates the display priority associated with the combination of the golf course ID of the target playing frame, the playing date, and the tee time in the reservation time table DB 14g with the determined display priority (Step S116), and the priority determination processing ends.

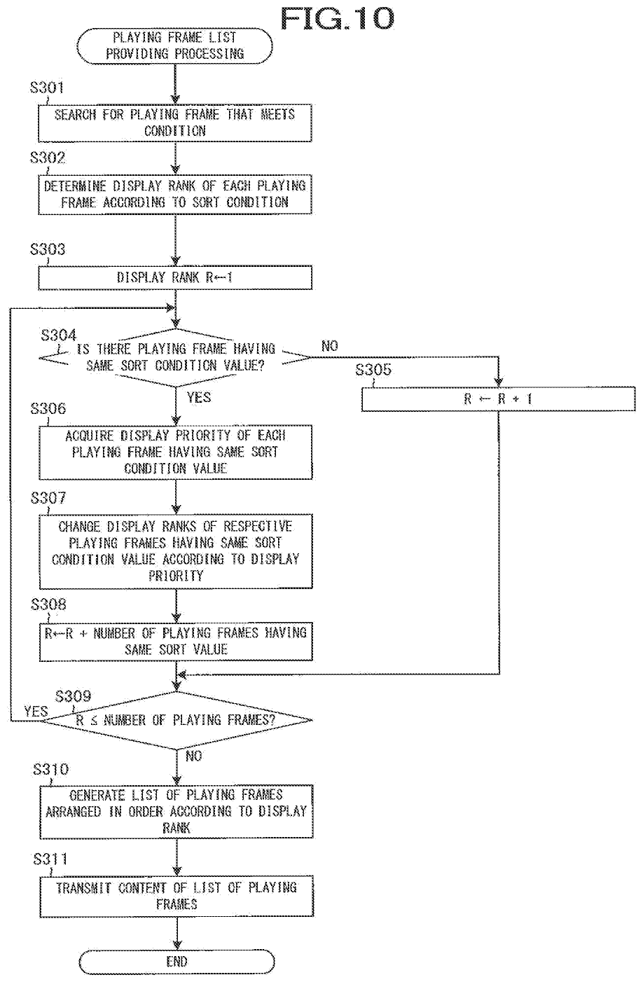

FIG. 10 is a flowchart illustrating an example of playing frame list providing processing performed by the system controller 11 of the golf course reservation server 1. For example, the controller 11 executes the playing frame list providing processing in response to receiving a request for a content including the list of playing frames from the user terminal 4.

As illustrated in FIG. 10, first, the display control unit 1103 searches for a playing frame that meets a preset condition or a search condition designated by the user (Step S301). Next, the display control unit 1103 determines a display rank of information on each found playing frame according to a preset sort condition or a sort condition designated by the user (Step S302). For example, the display control unit 1103 sorts the found playing frames in ascending or descending order of the sort value corresponding to the sort condition.

Next, the display control unit 1103 sets a display rank R to 1 (Step S303). Next, the display control unit 1103 determines whether or not there is at least one playing frame having the same sort value as a sort value of a playing frame with the display rank R among the playing frames whose display ranks are lower than R (Step S304). In a case where there is no playing frame having the same sort value as the sort value of the playing frame with the display rank R (Step S304: NO), the display control unit 1103 increases the display rank R by 1 (Step S305). On the other hand, in a case where there is at least one playing frame having the same sort value as the sort value of the playing frame with the display rank R (Step S304: YES), the display control unit 1103 acquires the display priority of each of the playing frames having the same sort value (including the playing frame with the display rank R) from the reservation time table DB 14g (Step S306). Next, the display control unit 1103 change the display ranks of the playing frames having the same sort value to each other according to the acquired display priority (Step S307). For example, the display control unit 1103 increases the display rank as the display priority is higher. Assume that the number of playing frames having the same sort value is N. The display control unit 1103 changes the display rank of each playing frame within a range of R to R+N−1. Next, the display control unit 1103 increases the display rank R by the number of playing frames having the same sort value (Step S308).

After increasing the display rank R (Step S305 or S309), the display control unit 1103 determines whether or not the display rank R is equal to or less than the number of found playing frames (Step S309). In a case where the display rank R is equal to or less than the number of found playing frames (Step S309: YES), the processing proceeds to Step S304. On the other hand, in a case where the display rank R is not equal to or less than the number of found playing frames (Step S309: NO), the display control unit 1103 generates the playing frame list (Step S310). For example, the display control unit 1103 generates the playing frame information of each playing frame based on the golf course DB 14b, the plan DB 14c, the reservation time table DB 14g, and the like. Then, the display control unit 1103 generates the playing frame list by arranging the pieces of playing frame information in the order according to the determined display rank. Next, the display control unit 1103 transmits the content including the generated playing frame list to the user terminal 4 (Step S311), and the playing frame list providing processing ends.

As described above, according to the present embodiment, the golf course reservation server 1 acquires the weather information indicating weather of at least one golf course at each of future playing frames included in playing frames of the at least one golf course in which the single person reservation is possible. The golf course reservation server 1 acquires the history information indicating the logs of whether any of reservation holders who have reservations for future playing frames canceled a reservation for any of bat weather playing frames among past playing frames reserved by these reservation holders. The golf course reservation server 1 controls the display priorities of the information on the bad weather future playing frames among the future playing frames based on the acquired history information. In this case, the display priorities of the information on the playing frames of the future playing times at which bad weather is expected is controlled based on the logs of whether any of reservation holders who have reservations for playing frames of future playing times canceled a reservation for any of playing frames at which weather was bad weather among playing frames of past playing times reserved by these reservation holders. It is possible to estimate a possibility that the reservation holder cancels the reservation for the playing frame of the future playing time at which bad weather is expected from the logs of the whether the reservation for the playing frame at which the weather is bad weather. Then, a possibility that the event of golf is to be held in the target playing frame changes depending on the possibility that the reservation holder cancels the reservation. Therefore, it is possible to provide information on playing frames to promote reservation for a playing frame at which an event of golf will be likely to be held based on weather h.

At this time, the golf course reservation server 1 may set the priority of the information on a bad weather playing frame that has been reserved by at least one reservation holder whose degree of tendency to cancel the reservation of the bad weather playing frame is lower than the predetermined degree to be higher than the priority of the information on a bad weather playing frame that has been reserved by at least one reservation holder whose degree of tendency to cancel the reservation of the bad weather playing frame is equal to or higher than the predetermined degree. In this case, the display of the information on the playing frame in which the possibility that the event of golf is to be held is relatively high can be prioritized over the display of the information on the playing frame in which the possibility that the event of golf is to be held is relatively low.

Here, the golf course reservation server 1 may set the priority of the information on the first bad weather playing frame on which the number of reservation holders whose degrees of tendency to cancel reservation of the bad weather playing frame is lower than the predetermined degree is equal to or more than the reference number to be higher than the priority of the information on the second bad weather future playing frame on which the number of reservation holders whose degrees of tendency to cancel reservation of the bad weather playing frame is lower than the predetermined degree is less than the reference number, among the bad weather future playing frames on which the number of reservation holders is equal to or more than the reference number. In this case, even if all the reservation holders who have high degrees of tendency to cancel the reservation of the bad weather playing frame cancel the reservations for the first bad weather playing frame, the number of reservation holders who still have reservations is equal to higher than the predetermined number, or the number of reservation holders reaches the predetermined number by the user to whom the information is provided reserving the first bad weather playing frame. If all the reservation holders who have high degrees of tendency to cancel the reservation of the bad weather playing frame cancel the reservations for the second bad weather playing frame, the number of reservation holders does not reach to the predetermined number regardless of whether the user to whom the information is provided reserves the second bad weather playing frame. The display of the information on the first bad weather future playing frame is prioritized over the display of the information on the second bad weather future playing frame. Therefore, it is possible to prioritize the display of the information on the playing frame in which the possibility that the event of golf is to be held is high.

### 2. Second Embodiment

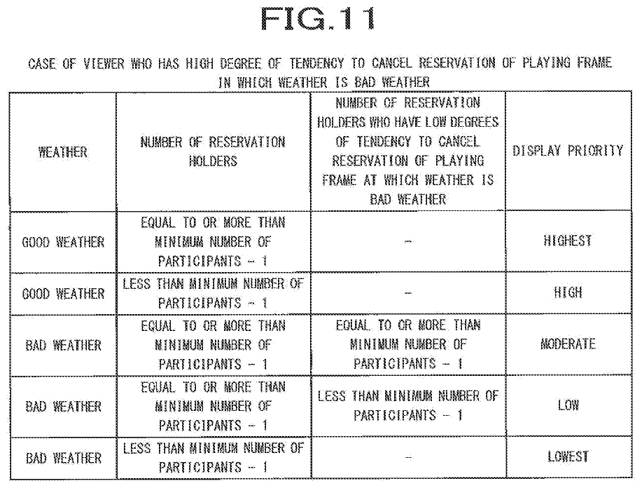

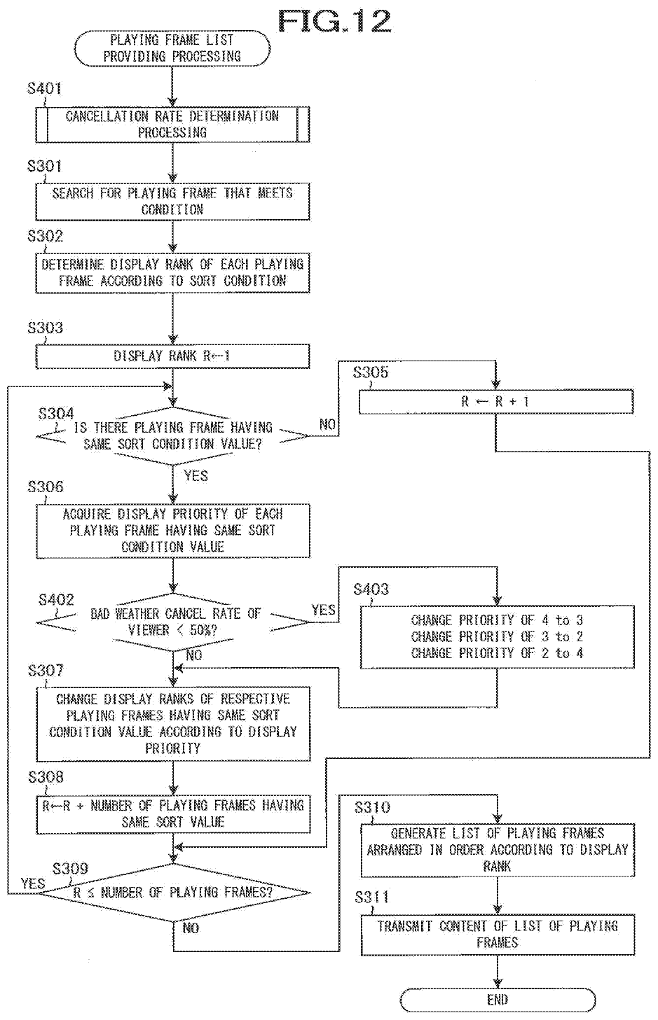

Next, a second embodiment will be described with reference to FIGS. 11 and 12. The second embodiment may be the same as the first embodiment except for the points described below. In the present embodiment, the golf course reservation server 1 may determine the display priorities of the playing frame information of the playing frames at which bad weather is expected based on the degree of tendency of a user to whom the playing frame information is to be presented to play golf in bad weather.

Specifically, the history information acquisition unit 1102 acquires the history information indicating logs of whether the user to whom the playing frame information is to be presented canceled a reservation for a bad weather past playing frame among past playing frames reserved by the user. Similarly to the first embodiment, the acquired history information may be at least one of the reservation information, the payment information, or the play history.

The display control unit 1103 controls the display priorities of the playing frame information further based on the history information of the user to whom the playing frame information is to be presented. Specifically, in a case where the degree of tendency of the target user to cancel the reservation of the bad weather playing frame is lower than the predetermined degree, the display control unit 1103 may determine which of display of information on a playing frame of a future playing time at which bad weather is expected on which the number of reservation holders who have reservations for this playing frame is equal to or more than the reference number and display of information on a playing frame of a future playing time at which good weather is expected is to be prioritized, based on the number of reservation holders of the playing frame of the future playing time at which good weather is expected. A user who has a low degree of tendency to cancel the reservation of the bad weather playing frame may reserve a playing frame at which the event of golf is expected to be held due to the number of reservation holders although bad weather is expected. In this case, it is preferable to determine the display priorities of the information on the playing frames according to the possibility that the event of golf is to be held. The possibility that the event of golf is to be held in the playing frame changes depending on the number of reservation holders of the playing frame at the present time. Therefore, which of a possibility that the event of golf is to be held at a playing frame at which good weather is expected and a possibility that the event of golf is to be held at a playing frame at which bad weather is expected but the golf is possibly to be held based on the number of reservation holders is changed according to the number of the reservation holders who have reservations for the playing frame at which good weather is expected.

On the other hand, in a case where the degree of tendency of the target user to cancel the reservation of the bad weather playing frame is equal to or higher than the predetermined degree, the display control unit 1103 may prioritize the display of the information on the playing frame of the future playing time at which good weather is expected over the display of the information on the playing frame of the future playing time at which bad weather is expected, regardless of the number of reservation holders of the playing frame of the future playing time at which good weather is expected. A user who has a high degree of tendency to cancel reservation of the bad weather playing frame is likely not to reserve a playing frame at which bad weather is expected in the first place. Therefore, by further lowering the display priority of the playing frame at which bad weather is expected, it is possible to reduce a possibility that the playing frame information unnecessary for the user is exposed to the user.

More specifically, in a case where the degree of tendency of the target user to cancel the reservation of the bad weather playing frame is lower than the predetermined degree, as illustrated in FIG. 6A, the display control unit 1103 may prioritize display of information on a first playing frame in which good weather is expected and of which the number of reservation holders is equal to or more than the reference number, over display of information on second and third playing frames in which bad weather is expected and of which the number of reservation holders is equal to or more than the reference number, and may prioritize the display of the information on the second and third playing frames over display of information on a fourth playing frame in which good weather is expected and of which the number of reservation holders is less than the reference number.

FIG. 11 is a diagram illustrating an example of a relationship between the combination of the weather and the number of reservation holders and the display priority in a case where a target user has a high degree of tendency to cancel reservation of a bad weather playing frame. FIG. 11 is different from FIG. 6A in that, in FIG. 11, the display priorities of pieces of information of two types of the playing frames at which bad weather is expected and on which the number of reservation holders is equal to or more than the reference number are lower than the display priority of information on the playing frame at which good weather is expected and on which the number of reservation holders is less than the reference number. As a whole, the display priority of the playing frames at which bad weather is expected is lower than the display priority of the playing frames at which good weather is expected.

FIG. 12 is a flowchart illustrating an example of playing frame list providing processing performed by the system controller 11 of the golf course reservation server 1. In FIG. 12, the same steps as those in FIG. 10 are denoted by the same reference signs. As illustrated in FIG. 12, first, the display control unit 1103 executes cancellation rate determination processing (Step S401). Except that the bad weather cancellation rate of the user of the user terminal 4 that has transmitted the request for the content to the golf course reservation server 1 is calculated using the reservation information of the user, the cancellation rate determination processing in Step S401 may be the same as the cancellation rate determination processing illustrated in FIG. 9. Next, Steps S302 to S304 are executed, and Step S305 or S306 is determined according to the determination result in S304. After Step S306, the display control unit 1103 determines whether or not the bad weather cancellation rate of the user of the user terminal 4 that has transmitted the request for the content is less than 50% (Step S402). In a case where the bad weather cancellation rate is less than 50% (Step S402: YES), Step S307 is executed. In a case where the bad weather cancellation rate is not less than 50% (Step S402: NO), the display control unit 1103 changes the display priorities acquired in Step S306 (Step S403). For example, the display control unit 1103 changes the display priority from 4 to 3, changes the display priority from 3 to 2, and changes the display priority from 2 to 4. Next, the display control unit 1103 changes the display rank of the respective playing frames having the same sort value according to the changed display priority (Step S307). After Step S307, Steps S308 and S309 are executed, and Step S304 is executed or Steps S310 and S311 are executed according to the determination result of Step S309.

As described above, according to the present embodiment, the display priority is controlled further based on the logs of whether the user to whom the information is to be presented canceled a reservation for the bad weather playing frame among the playing frames of the past playing times reserved by the user. It is possible to estimate a possibility that the user to whom the information is to be provided cancels the reservation of the playing frame of the future playing time at which bad weather is expected from the logs of whether the user canceled the reservation for the bad weather playing frame. Then, the possibility that the user to whom the information is to be provided cancels the reservation changes a possibility that the user reserves the bad weather playing frame.

Furthermore, in a case where the user to whom the information is to be provided has a low degree of tendency to cancel reservation for the bad weather playing frame, which of the display of the bad weather playing frame on which the number of reservation holders is equal to or more than a number that is the reference number and the display of the playing frame in which the weather is different from bad weather is to be prioritized is determined based on the number of reservation holders of the playing frame at which the weather is different from bad weather. The playing frame on which the number of reservation holders is equal to or more than the predetermined number at the present time or the number of reservation holders reaches the predetermined number as the user to whom the information is provided makes a reservation is a playing frame at which the event of golf is expected to be held in consideration of only the number of reservation holders at the present time. A user who has a low degree of tendency to cancel reservation of a bad weather playing frame may reserve a playing frame at which the event of golf is expected to be held at the present time even if bad weather is expected. The possibility that the event of golf is to be held at the playing frame at which the weather is different from bad weather can be estimated from the number of reservation holders of the playing frame at the present time. Then, which of a possibility that the event of golf is to be held at the playing frame at which the weather is different from bad weather and a possibility that the event of golf is to be held at the bad weather playing frame and the event of golf is possibly to be held in consideration of only the number of reservation holders is higher is changed based on the number of reservation holders of the playing frame at which the weather is different from bad weather. Therefore, it is possible to prioritize the display of the information on the playing frame at which the possibility that the event of golf is to be held is high. Meanwhile, in a case where the user to whom the information is to be provided has a high degree of tendency to cancel reservation of a bad weather playing frame, the display of the information on the playing frame at which the weather is different from bad weather is prioritized over the display of the information on the bad weather playing frame. A user who has a high degree of tendency to cancel reservation of a bad weather playing frame is less likely to reserve such a playing frame.

Therefore, in a case where the user to whom the information is to be provided has a low degree of tendency to cancel reservation of a bad weather playing frame, it is possible to prioritize display of information on a playing frame in which the possibility that the event of golf is to beheld is high. Furthermore, in a case where the user to whom the information is to be provided has a high degree of tendency to cancel reservation of a bad weather playing frame, it is possible to prioritize display of a playing frame that is more likely to be reserved by the user.

1. An information provision device comprising:
at least one memory configured to store computer program code;
at least one processor configured to access the at least one memory and operate as instructed by the computer program code, the computer program code including:
weather information acquisition code configured to cause at least one of the at least one processor to acquire weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame;
history information acquisition code configured to cause at least one of the at least one processor to acquire history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and
control code configured to cause at least one of the at least one processor to control, based on the acquired history information, display priorities of information on specific future playing frames included in the future playing frames, wherein weather at each of the specific future playing frames indicated by the acquired weather information is the predetermined weather.

2. The information provision device according to claim 1,
wherein the control code is configured to cause at least one of the at least one processor to set a priority of the information on a first playing frame included in the specific future playing frames to be higher than a priority of the information on a second playing frame included in the specific future playing frames,
the first playing frame is a playing frame that has been reserved by at least one first reservation holder, included in the specific reservation holders, whose degree of tendency to cancel the reservation for any of the past specific playing frames is lower than the predetermined degree, and
the second playing frame is a playing frame that has been reserved by at least one second reservation holder, included in the specific reservation holders, whose degree of tendency to cancel the reservation for any of the past specific playing frames is equal to or higher than the predetermined degree.

3. The information provision device according to claim 1,
wherein the control codes is configured to cause at least one of the at least one processor to set a priority of the information on a first playing frame included in the specific future playing frames to be higher than a priority of the information on a second playing frame included in the specific future playing frames,
the first playing frame is a playing frame that has been reserved by first reservation holders, included in the specific reservation holders, whose degree of tendency to cancel the reservation for any of the past specific playing frames is lower than the predetermined degree,
a number of the first reservation holders is equal to or more than a reference number,
the second playing frame is a playing frame that has been reserved by second reservation holders,
a number of the second reservation holders is equal to or more than the reference number,
a number of third reservation holders, among the second reservation holders, whose degree of tendency to cancel the reservation of any of the specific playing frames is lower than the predetermined degree is less than the reference number, and
the reference number is one less than the predetermined number.

4. The information provision device according to claim 1, wherein
the history information acquisition code is further configured to cause at least one of the at least one processor to acquire second history information indicating logs of whether a user to whom information on at least one of the future playing frames is to be presented canceled a reservation for any of the past specific playing frames, and
the control code is configured to cause at least one of the at least one processor to control the display priorities further based on the acquired second history information.

5. The information provision device according to claim 4, wherein
the control code is configured to cause at least one of the at least one processor to determine which of display of information on a first playing frame and display of information on a second playing frame is to be prioritized based on a number of reservation holders who have reservations for the second playing frame in a case where a degree of tendency for the user to cancel the reservation of any of the past specific playing frames is lower than a predetermined degree,
the control code is further configured to cause at least one of the at least one processor to prioritize the display of the information on the second playing frame over the display of the information on the second playing frame regardless of the number of reservation holders who have reservations for the second playing frame in a case where the degree is equal to or higher than the predetermined degree,
the first playing frame is included in the future specific playing frames and a number of reservation holders who have reservations for the first playing frame is equal to or more than a reference number,
the reference number is one less than the predetermined number, and
the second playing frame is included in the future playing frames and weather at the second playing frame indicated by the acquired weather information is different from the predetermined weather.

6. An information provision method performed by a computer, the method comprising:
acquiring weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame;
acquiring history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and
controlling, based on the acquired history information, display priorities of information on specific future playing frames included in the future playing frames, wherein weather at each of the specific future playing frames indicated by the acquired weather information is the predetermined weather.

7. A non-transitory computer readable medium storing thereon an information provision program, the information provision program causing a computer to:
acquire weather information indicating weather of at least one golf course at each of future playing frames included in playing frames of the at least one golf course, wherein each of the playing frames is indicated by a location where golf is played and a playing time, each of the future playing frame is indicated by a future playing time, and wherein, in a case where a number of reservation holders who have reservations for a playing frame among the playing frames is equal to or more than a predetermined number, the reservation holders are grouped together and the grouped reservation holders can play golf at the reserved playing frame;
acquire history information indicating logs of whether any of specific reservation holders canceled a reservation for any of past specific playing frames, wherein each of the past specific playing frames is included in the playing frames and indicated by a past playing time, weather at each of the past specific playing frames is predetermined weather that possibly has a negative impact on playing golf, and each of the specific reservation holders has a reservation for one of the future playing frames; and
control, based on the acquired history information, display priorities of information on specific future playing frames included in the future playing frames, wherein weather at each of the specific future playing frames indicated by the acquired weather information is the predetermined weather.
